(19) United States
(12) Patent Application Publication
(10) Pub. No.: US 2017/0197806 A1
(43) Pub. Date: Jul. 13, 2017

(54) ELEVATOR TENSION PULLEY DEVICE

(71) Applicant: MITSUBISHI ELECTRIC CORPORATION, Chiyoda-ku, Tokyo (JP)

(72) Inventor: Takeshi NIIKAWA, Chiyoda-ku (JP)

(73) Assignee: MITSUBISHI ELECTRIC CORPORATION, Chiyoda-ku, Tokyo (JP)

(21) Appl. No.: 15/326,086

(22) PCT Filed: Sep. 17, 2014
(86) PCT No.: PCT/JP2014/074504

§ 371 Date: Jan. 13, 2017

(51) Int. Cl. B66B 7/10; B66B 3/02

(52) U.S. Cl. CPC B66B 7/10; B66B 3/02

(57) ABSTRACT

In an elevator tension pulley device, a guide plate is fixed to a guide rail via a support arm, and a tension pulley moves while being guided in a vertical direction as a main shaft inserted into an elongated hole in the guide plate moves vertically through the elongated hole. As a result, the number of components of the elevator tension pulley device can be reduced, and the elevator tension pulley device can be installed in a hoistway easily.

### TECHNICAL FIELD

This invention relates to an elevator tension pulley device around which a speed governor rope is stretched.

### BACKGROUND ART

A conventional elevator tension pulley device includes a frame body that supports a tension pulley rotatably, a weight mounted on the frame body, a vertical rail portion that guides the frame body, and an upper/lower pair of support arms that are mounted on a guide rail so as to support the vertical rail, wherein the frame body includes a U-shaped body into which the vertical rail portion is inserted and a pair of engaging bodies that are engaged to respective side portions of the vertical rail portion, and a speed governor rope is stretched around the elevator tension pulley device by the weight of the weight via the tension pulley (see PTL 1, for example).

### CITATION LIST

### Patent Literature

[PTL 1] Japanese Patent Application Publication No. H7-257856

### SUMMARY OF INVENTION

### Technical Problem

In the elevator tension pulley device described above, however, the vertical rail portion, the upper/lower pair of support arms that support the vertical rail portion, the U-shaped body into which the vertical rail portion is inserted, and the engaging bodies for restricting horizontal direction movement of the tension pulley are all required to guide the tension pulley in a vertical direction, and therefore the number of components is large. Moreover, installing the elevator tension pulley device having all of these components in a hoistway involves a large amount of labor.

This invention has been designed to solve the problems described above, and an object thereof is to obtain an elevator tension pulley device that has a reduced number of components, is easy to install in a hoistway, and so on.

### Solution to Problem

An elevator tension pulley device according to this invention includes:
a tension pulley that is provided in a bottom portion of a hoistway in order to apply tension to a speed governor rope;
a main shaft, one end portion of which supports the tension pulley to be free to rotate; and
a guide member that is mounted on a guide rail for guiding a car, and includes an elongated hole extending in a vertical direction, wherein
the tension pulley moves while being guided in the vertical direction as the main shaft, which is inserted into the elongated hole, moves vertically through the elongated hole.

### Advantageous Effects of Invention

With the elevator tension pulley device according to this invention, the tension pulley moves while being guided in the vertical direction as the main shaft inserted into the elongated hole moves vertically through the elongated hole, and as a result, the number of components of the elevator tension pulley device can be reduced, the elevator tension pulley device can be installed in the hoistway more easily, and so on.

### BRIEF DESCRIPTION OF DRAWINGS

FIG. 1 is a front view showing an elevator tension pulley device according to a first embodiment of this invention.

FIG. 2 is a side view showing the elevator tension pulley device of FIG. 1.

FIG. 3 is a plan view showing the elevator tension pulley device of FIG. 1.

FIG. 4 is an enlarged view of a site A shown in FIG. 2.

FIG. 5 is a front view showing a manner in which the elevator tension pulley device of FIG. 1 is used.

FIG. 6 is a sectional view showing main parts of an elevator tension pulley device according to a second embodiment of this invention.

FIG. 7 is a front view showing an elevator tension pulley device according to a third embodiment of this invention.

FIG. 8 is a side view showing the elevator tension pulley device of FIG. 7.

FIG. 9 is a front view showing a manner in which the elevator tension pulley device of FIG. 7 is used.

FIG. 10 is a side view showing the elevator tension pulley device of FIG. 9.

FIG. 11 is a plan view showing an elevator tension pulley device according to a fourth embodiment of this invention.

### DESCRIPTION OF EMBODIMENTS

Embodiments of an elevator tension pulley device according to this invention will be described below on the basis of the drawings. Identical or corresponding members and sites in the drawings will be described using identical reference numerals.

### First Embodiment

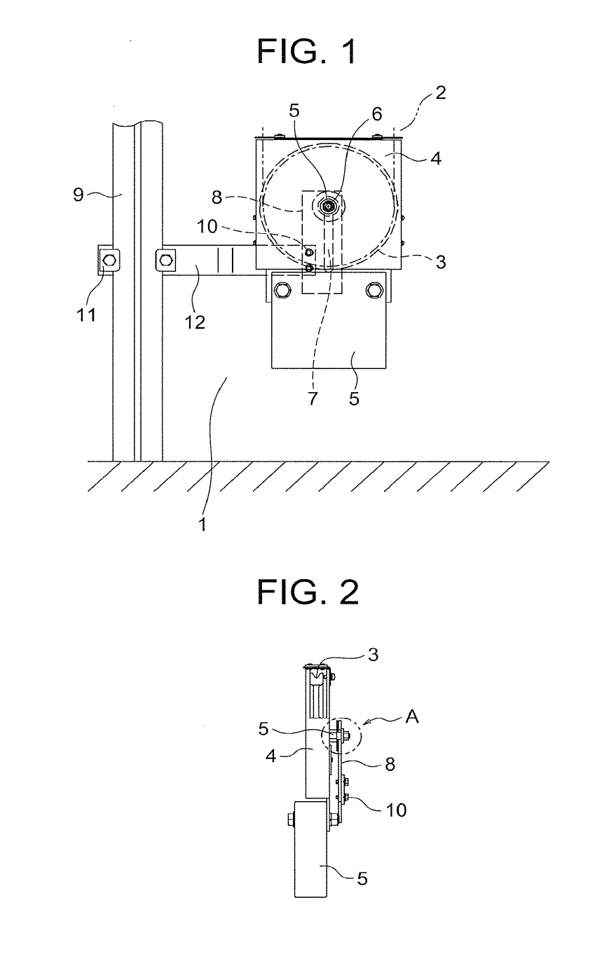

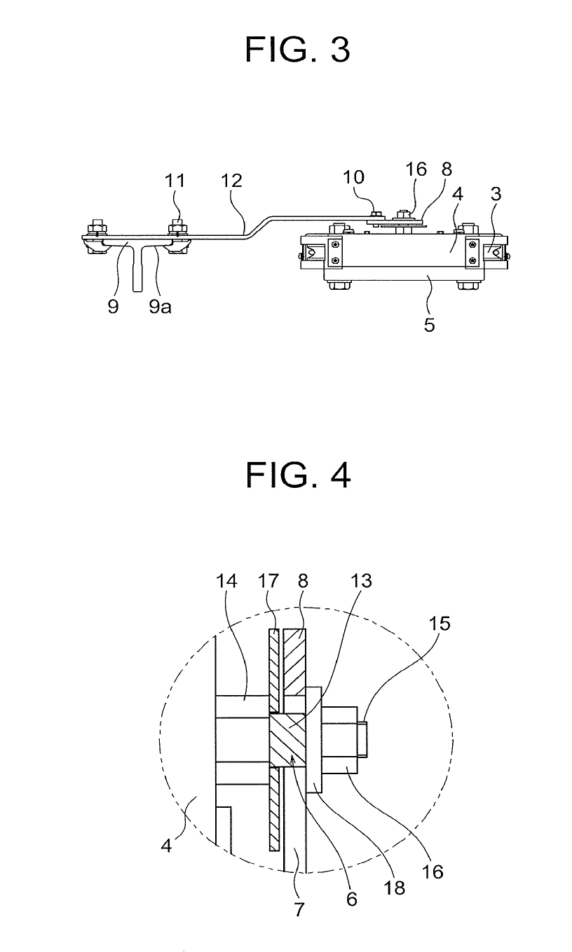

FIG. 1 is a front view showing an elevator tension pulley device according to a first embodiment of this invention. FIG. 2 is a side view showing the elevator tension pulley device of FIG. 1. FIG. 3 is a plan view showing the elevator tension pulley device of FIG. 1.

The elevator tension pulley device includes a tension pulley 3 around which a lower end portion of a speed governor rope 2 is wound, the speed governor rope 2 being suspended within a hoistway 1, a case 4 housing the tension pulley 3, a weight 5 fixed to a lower portion of the case 4, a main shaft 6, one end portion of which supports the tension pulley 3 to be free to rotate and another end portion of which projects from the case 4 in a horizontal direction, a guide plate 8 having an elongated hole 7 for guiding the main shaft 6, which is inserted therein, in a vertical direction, and a support arm 12, one end portion of which is fixed to the guide plate 8 by a connection fitting 10 and another end portion of which is mounted detachably via a mounting fitting 11 on a guide rail 9 that extends in a perpendicular direction to the support arm 12.

The support arm 12 is bent into a step shape in an intermediate portion thereof, as shown in FIG. 3, and the tension pulley 3 is disposed parallel to a leg portion 9a of the guide rail 9, as shown in FIG. 3.

Here, the guide plate 8 and the support arm 12 together constitute a guide member.

The speed governor rope 2 is stretched endlessly between a speed governor (not shown) provided in a machine room and the tension pulley 3, which is provided in a bottom portion of the hoistway 1, and connected to a pull-up rod of a safety device (not shown) provided in the car.

FIG. 4 is an enlarged view of a site A shown in FIG. 2.

Note that a part of FIG. 4 shows a cross-section.

The main shaft 6, which is fixed to a wall portion of the case 4, includes an inserted portion 13 that has a smooth surface and is inserted into the elongated hole 7 in the guide plate 8, and a hexagonal portion 14 serving as an enlarged portion that is coaxial with the inserted portion 13 but has a larger radial direction dimension than the inserted portion 13 in order to restrict movement of the main shaft 6 toward the guide plate 8 side.

Main shaft mounting means for mounting the main shaft 6 on the guide plate 8 are provided on an end portion of the main shaft 6 on an opposite side to the tension pulley 3.

The main shaft mounting means includes a screw portion 15 formed on a peripheral surface of the end portion of the main shaft 6, and the nut 16 that is screwed to the screw portion 15 to prevent the main shaft 6 from becoming dislodged from the guide plate 8.

A first washer 17 is fitted onto the inserted portion 13 of the main shaft 6, and a second washer 18 is fitted onto the screw portion 15. The first washer 17 and the second washer 18 sandwich the guide plate 8 from respective surfaces thereof.

The elevator tension pulley device according to this embodiment is installed in the hoistway 1 by mounting the support arm 12 on the leg portion 9a of the guide rail 9 using the mounting fitting 11 in accordance with the length of the speed governor rope 2.

The speed governor rope 2 is pulled in a downward direction at all times by the weight of the tension pulley 3, the weight 5, and the case 4 such that tension is generated in the speed governor rope 2 at all times, and as a result, the speed governor rope 2 expands and contracts in response to variation in the air temperature and humidity, and so on.

In conjunction with the expansion and contraction of the speed governor rope 2, the tension pulley 3 moves vertically, and at this time, the inserted portion 13 of the main shaft 6 moves in the vertical direction while being guided through the elongated hole 7 in the guide plate 8. As a result, the tension pulley 3, the weight 5, and the case 4 move integrally while being guided in the vertical direction.

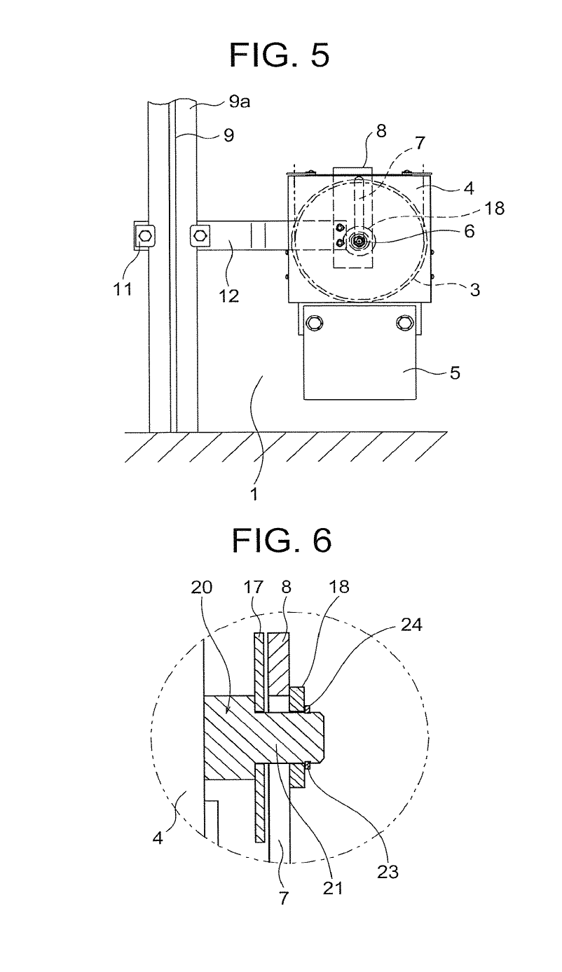

FIG. 5 is a front view showing the elevator tension pulley device in a condition where the tension pulley 3, the weight 5, and the case 4 have descended in response to expansion of the speed governor rope 2, with the result that the main shaft 6 is positioned on a lower end side of the guide rail 9 in the guide plate 8.

The elevator tension pulley device according to this embodiment includes the tension pulley 3 that is provided in the bottom portion of the hoistway 1 in order to apply tension to the speed governor rope 2, the main shaft 6, one end portion of which supports the tension pulley 3 to be free to rotate, and the guide member that is mounted via the support arm 12 on the leg portion 9a of the guide rail 9 for guiding the car, and includes the elongated hole 7 that extends in the vertical direction, wherein the tension pulley 3 is guided in the vertical direction as the inserted portion 13 of the main shaft 6, which is inserted into the elongated hole 7, moves vertically through the elongated hole 7.

Hence, in this elevator tension pulley device, the tension pulley 3 moves while being guided in the vertical direction rather than moving through the hoistway 1 in a horizontal direction, and as a result, an undesirable situation in which the speed governor rope 2 displaces in the horizontal direction so as to interfere with devices disposed in the hoistway 1 and so on can be prevented from occurring.

Further, the number of components can be reduced greatly in comparison with the conventional elevator tension pulley device described above, in which the vertical rail portion, the upper/lower pair of support arms, and so on are provided to guide the tension pulley in the vertical direction.

Furthermore, the elevator tension pulley device according to this embodiment is configured simply, and can be installed in the hoistway 1 easily.

Moreover, the main shaft 6 include the inserted portion 13 that is inserted into the elongated hole 7 and the hexagonal portion 14 that is coaxial with the inserted portion 13 but has a larger radial direction dimension than the inserted portion 13 so as to exceed a horizontal direction dimension of the elongated hole 7, and the nut 16 is screwed to the peripheral surface of the other end portion of the main shaft 6. Hence, the main shaft 6 is configured simply, and is mounted on the guide plate 8 so as to be capable of moving in the vertical direction through the elongated hole 7.

Furthermore, the first washer 17 and the second washer 18 are provided on the main shaft 6 so as to be fitted close to the respective side faces of the guide plate 8, and therefore a gap between the guide plate 8 and the hexagonal portion 14 and a gap between the guide plate 8 and the nut 16 can be reduced, with the result that an amount by which the main shaft 6 moves in the horizontal direction relative to the guide plate 8 can be suppressed easily.

### Second Embodiment

FIG. 6 is a sectional view showing main parts of an elevator tension pulley device according to a second embodiment.

In the elevator tension pulley device according to this embodiment, a main shaft 20 fixed to the wall portion of the case 4 includes an inserted portion 21 that is inserted into the elongated hole 7 and a columnar portion 22 serving as an enlarged portion that is coaxial with the inserted portion 21 but has a larger radial direction dimension than the inserted portion 21 in order to restrict movement of the main shaft 20 toward the guide plate 8 side, while main shaft mounting means for mounting the main shaft 20 on the guide plate 8 are provided on another end portion of the main shaft 20 on the opposite side to the tension pulley 3.

The main shaft mounting means includes a groove portion 23 formed in the main shaft so as to extend in a circumferential direction, and a snap ring 24 that is fitted to the groove portion 23 to prevent the main shaft 20 from becoming dislodged from the guide plate 8.

All other configurations are identical to the elevator tension pulley device of the first embodiment.

In the elevator tension pulley device according to this embodiment, similarly to the elevator tension pulley device of the first embodiment, the main shaft 20 is mounted on the guide plate 8 so as to be capable of moving in the vertical direction through the elongated hole 7 by means of a simple configuration.

### Third Embodiment

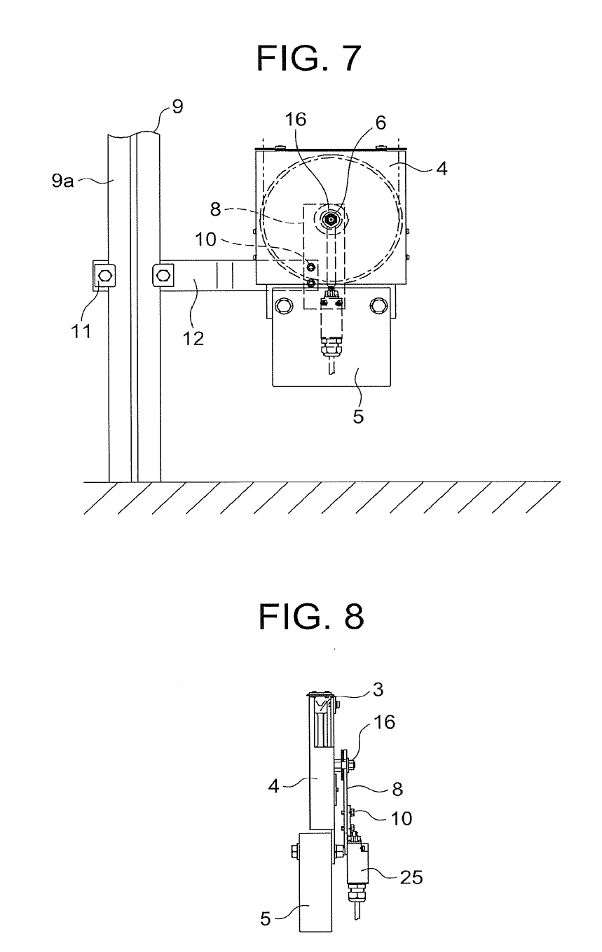

FIG. 7 is a front view showing an elevator tension pulley device according to a third embodiment of this invention, and FIG. 8 is a side view showing the elevator tension pulley device of FIG. 7.

In this elevator tension pulley device, a position detection switch 25 for detecting the position of the main shaft 6 is mounted on a lower portion of the guide plate 8 so as to oppose the weight 5. The nut 16 is fixed to the main shaft 6 as a detected portion that contacts the position detection switch 25. In this embodiment, the nut 16 doubles as a contact portion.

All other configurations are identical to the elevator tension pulley device of the first embodiment.

As the speed governor rope 2 expands, the tension pulley 3 descends, and when the main shaft 6 contacts a lower surface of the elongated hole 7 in the guide plate 8, a force for pulling the speed governor rope 2, which is generated by the weight of the tension pulley 3, the weight 5, and the case 4, no longer acts on the speed governor rope 2. As a result, the tension in the speed governor rope 2 is inevitably lost. Accordingly, rotary force from the speed governor rope 2 is no longer applied to a sheave of the speed governor, which is supposed to rotate in synchronization with the descent of the car, and as a result, the speed governor cannot function as required.

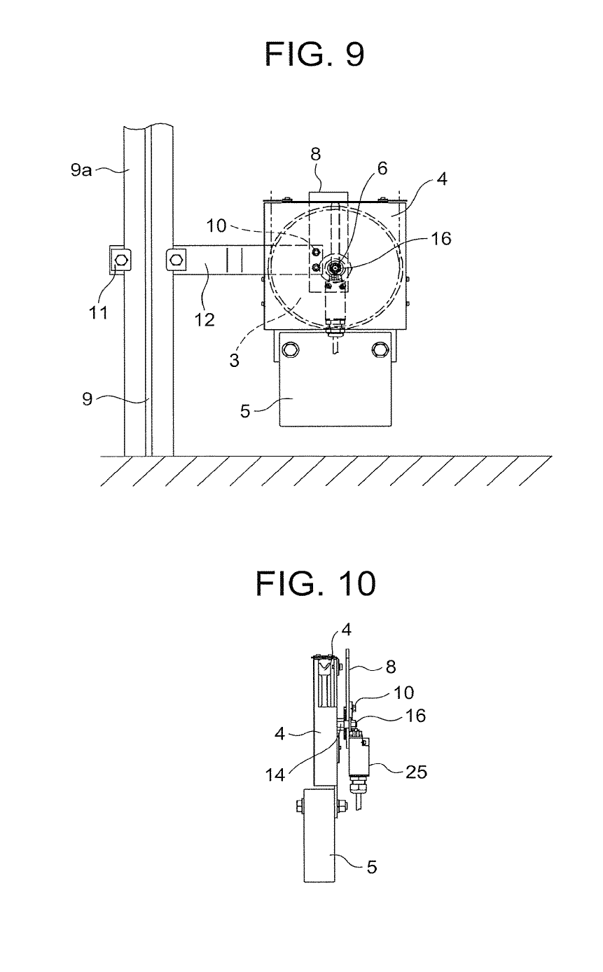

To forestall this situation, in this embodiment, as shown in FIGS. 9 and 10, when the speed governor rope 2 expands such that the tension pulley 3 descends, the nut 16 fixed to the end portion of the main shaft 6 is set to contact the position detection switch 25 before the main shaft 6 contacts the lower surface of the elongated hole 7 in the guide plate 8, and therefore a third party can realize that the speed governor rope 2 has expanded to a degree exceeding an allowable value. As a result, a situation in which the tension in the speed governor rope 2 is lost can be forestalled.

In the elevator tension pulley device according to this embodiment, a situation in which the tension in the speed governor rope 2 is lost can be forestalled by means of a simple configuration in which the position detection switch 25 is added to the lower portion of the guide plate 8 extending in the vertical direction.

### Fourth Embodiment

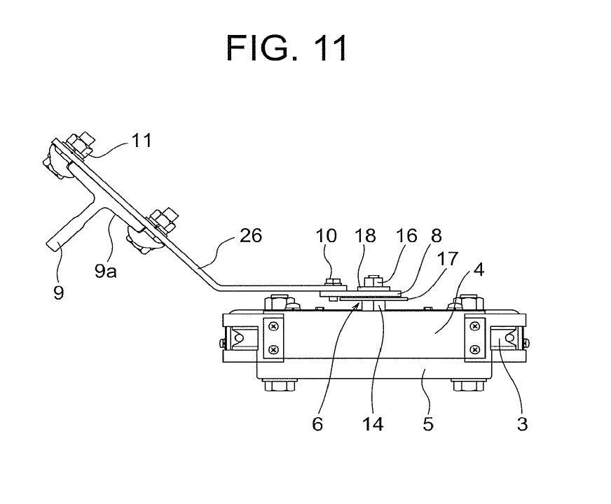

FIG. 11 is a plan view showing an elevator tension pulley device according to a fourth embodiment of this invention.

In the elevator tension pulley devices according to the first to third embodiments, the support arm 12 bent into a step shape in the intermediate portion thereof extends in the horizontal direction from the leg portion 9a of the guide rail 9, the guide plate 8 is fixed thereto, and the tension pulley 3 is disposed so as to extend parallel to the leg portion 9a of the guide rail 9.

In the elevator tension pulley device according to the fourth embodiment, on the other hand, a support arm 26 that extends in the horizontal direction from the leg portion 9a of the guide rail 9 is bent midway so that the tension pulley 3 is disposed at an angle relative to the leg portion 9a of the guide rail 9.

All other configurations are identical to the elevator tension pulley device of the first embodiment.

In the elevator tension pulley device according to this embodiment, the tension pulley 3 is disposed so as to extend at an angle relative to the leg portion 9a of the guide rail 9, while the elongated hole 7 in the guide plate 8 is provided to extend in the vertical direction even though the tension pulley 3 is not disposed to extend parallel to the leg portion 9a of the guide rail 9.

Hence, the tension pulley 3 can move in the vertical direction, and even when the tension pulley 3 moves in the vertical direction, a planar area occupied exclusively thereby does not vary. Therefore, in comparison with a so-called lever type tension pulley that also moves in the horizontal direction while moving in the vertical direction, an amount of space occupied by the tension pulley 3, and accordingly the risk of interference thereof with other components, can be reduced.

Note that in the embodiments described above, the guide member having the elongated hole that extends in the vertical direction is constituted by two members, namely the support arm 12, 26 and the guide plate 8, but may be constituted by a single member.

Further, as examples of specific configurations of the main shaft mounting means, the screw portion 15 and the nut 16 were cited in the first embodiment, while the groove portion 23 and the snap ring 24 were cited in the second embodiment. However, the invention is of course not limited to these examples, and the main shaft may be mounted on the guide plate by forming an insertion hole in the end portion of the main shaft so as to penetrate the main shaft in the horizontal direction, and inserting an insertion pin into the insertion hole.

Furthermore, the first washer 17 and the second washer 18 maybe fitted close to one of the two side faces of the guide plate 8.

Moreover, the nut 16 was described as an example of the detected portion that contacts the position detection switch, but the nut 16 is merely an example, and any component that moves integrally with the main shaft 6 so as to contact the position detection switch 25 may be used as the detected portion.

### REFERENCE SIGNS LIST

1 Hoistway

2 Speed governor rope

3 Tension pulley

4 Case

5 Weight

6, 20 Main shaft

7 Elongated hole

8 Guide plate

9 Guide rail

9a Leg portion

10 Connection fitting

11 Mounting fitting

12, 26 Support arm

13, 21 Inserted portion

14 Hexagonal portion (enlarged portion)

15 Screw portion (main shaft mounting means)

16 Nut (main shaft mounting means)

17 First washer

18 Second washer

22 Columnar portion (enlarged portion)

23 Groove portion (main shaft mounting means)

24 Snap ring (main shaft mounting means)

25 Position detection switch

1. An elevator tension pulley device comprising:
a tension pulley that is provided in a bottom portion of a hoistway in order to apply tension to a speed governor rope;
a main shaft, one end portion of which supports the tension pulley to be free to rotate; and
a guide member that is mounted on a guide rail for guiding a car, and includes an elongated hole extending in a vertical direction, wherein
the tension pulley moves while being guided in the vertical direction as the main shaft, which is inserted into the elongated hole, moves vertically through the elongated hole.

2. The elevator tension pulley device according to claim 1, wherein the guide member is constituted by a support arm, one end portion of which is mounted on the guide rail so as to extend in a horizontal direction, and a guide plate that is mounted on another end portion of the support arm so as to extend in the vertical direction, and that includes the elongated hole.

3. The elevator tension pulley device according to claim 2, wherein the main shaft comprises an inserted portion that is inserted into the elongated hole, and an enlarged portion that is coaxial with the inserted portion but has a larger radial direction dimension than the inserted portion so as to restrict movement of the main shaft towards the guide plate side, and
main shaft mounting means for mounting the main shaft on the guide plate is provided on another end portion of the main shaft.

4. The elevator tension pulley device according to claim 2, wherein a washer is provided on the main shaft so as to be fitted close to at least one side face of the guide plate.

5. The elevator tension pulley device according to claim 2, wherein a position detection switch that is activated when contacted by a detected portion that moves in conjunction with the main shaft is provided in a lower portion of the guide plate, and
the detected portion contacts the position detection switch before the main shaft contacts a lower end portion of the elongated hole.

6. The elevator tension pulley device according to claim 1, wherein the tension pulley is disposed parallel to a leg portion of the guide rail.

7. The elevator tension pulley device according to claim 1, wherein the tension pulley is disposed at an angle relative to a leg portion of the guide rail.

8. The elevator tension pulley device according to claim 3, wherein the main shaft mounting means comprises a screw portion formed on a peripheral surface of the main shaft, and a nut that is screwed to the screw portion to prevent the main shaft from becoming dislodged from the guide plate.

9. The elevator tension pulley device according to claim 3, wherein the main shaft mounting means comprises a groove portion formed in the main shaft so as to extend in a circumferential direction, and a snap ring that is fitted to the groove portion to prevent the main shaft from becoming dislodged from the guide plate.

10. The elevator tension pulley device according to claim 3, wherein a washer is provided on the main shaft so as to be fitted close to at least one side face of the guide plate.

11. The elevator tension pulley device according to claim 2, wherein a position detection switch that is activated when contacted by a detected portion that moves in conjunction with the main shaft is provided in a lower portion of the guide plate, and
the detected portion contacts the position detection switch before the main shaft contacts a lower end portion of the elongated hole.

12. The elevator tension pulley device according to claim 3, wherein a position detection switch that is activated when contacted by a detected portion that moves in conjunction with the main shaft is provided in a lower portion of the guide plate, and
the detected portion contacts the position detection switch before the main shaft contacts a lower end portion of the elongated hole.

13. The elevator tension pulley device according to claim 10, wherein a position detection switch that is activated when contacted by a detected portion that moves in conjunction with the main shaft is provided in a lower portion of the guide plate, and
the detected portion contacts the position detection switch before the main shaft contacts a lower end portion of the elongated hole.
